(19) United States
(12) Patent Application Publication
(10) Pub. No.: US 2007/0163592 A1
(43) Pub. Date: Jul. 19, 2007

(54) GAS RESERVOIR BAG, DISTRIBUTOR HOUSING, BREATHING MASK, AND RESPIRATION METHOD

(76) Inventors: Jurgen Reinstadtler, Wurzburg (DE); Eckard Glaser, Gerbrunn (DE)

Correspondence Address: KING & SCHICKLI, PLLC, 247 NORTH BROADWAY, LEXINGTON, KY, 40507, US

(21) Appl. No.: 11/676,633

(22) Filed: Feb. 20, 2007

Related U.S. Application Data
(63) Continuation of application No. PCT/DE05/01406, filed on Aug. 9, 2005.

(30) Foreign Application Priority Data
Aug. 21, 2004 (DE) 10 2004 040 740.1

(51) Int. Cl. A62B 23/02; A62B 18/02; A62B 7/10

(52) U.S. Cl. 128/205.27; 128/206.21

(57) ABSTRACT

The present invention relates to a gas reservoir bag (6), comprising a flexible bag (9) for separating two different gases with a connection. The gas reservoir bag further comprises an outer bag (8) for generating a pressure difference between the flexible bag (9) and the ambiance of the outer bag (8), wherein the outer bag (8) surrounds the flexible bag (9) except for the connection thereof. The invention moreover relates to a distributor housing for a respiratory mask having such a gas reservoir bag and to a respiratory mask having such a distributor housing. The invention finally relates to corresponding methods.

### CROSS REFERENCE TO RELATED CO-PENDING APPLICATIONS

This application is a continuation of international application number PCT/DE2005/001406 (publication number: WO 2006/021182 A1) filed on Aug. 9, 2005 and entitled GAS RESERVOIR BAG, DISTRIBUTOR HOUSING, BREATHING MASK, AND RESPIRATION METHOD and claims the benefit of the above-mentioned international application and the corresponding German national patent application number 10 2004 040 740.1 filed on Aug. 21, 2004 and entitled GASRESERVOIRBEUTEL, VERTEILERGEHÄUSE, BEATMUNGSMASKE SOWIE BEATMUNGSVERFAHREN the contents of which are expressly incorporated herein by reference.

### Field of the Invention

The invention relates to apparatus and accessories for the application of oxygen and other gases. The invention specifically relates to respiratory masks and gas reservoir bags therefor.

### BACKGROUND OF THE INVENTION

A respiratory mask for the effective respiration with oxygen or other gases is known from EP 1 402 915 A1. FIG. 2 of the present application shows FIG. 1 of EP 1 402 915 A1, in which the reference numerals have been maintained. FIG. 2 shows a mask configuration 10 comprising a face piece 20, a hollow distributor housing 30 and a gas reservoir gab 40. The face piece 20 includes a clearance 27 to which the distributor housing 30 is connected. The distributor housing 30 is a hollow structure with a piping, which includes an inspiration passage or arm 50 and an expiration passage or arm 60. The inspiration arm conducts the oxygen supplied through a gas inlet connection 52 toward the face piece 20. The expiration arm 60 conducts the expired gas from the face piece 20 via an outlet connection 62 into the ambient atmosphere. The distributor housing 30 may further comprise a channel 70 which conducts indoor air from the ambient atmosphere into the inspiration arm 50. The reservoir bag 40 may be connected to the end of the piping of the inspiration arm 50.

An inspiration valve 54 is arranged in the inspiration arm 50 between the face piece 20 and the gas reservoir bag 40. The gas reservoir bag 40 merely serves as a separation wall between the gas, mostly oxygen, in its interior and the ambient atmosphere. Thus, there is an ambient pressure in the gas reservoir bag 40. The inspiration valve 54 opens during the inspiration, more exactly, when the pressure in the face piece 20 drops below the ambient pressure by 1.5 mbar.

An expiration valve 64 in the expiration arm 60 opens during the expiration so that the expired air flows from the face piece 20 to the outlet connection 62 where it is released into the ambiance.

A dilution valve 72 in channel 70 opens during the inspiration when the gas reservoir bag 40 is empty and a gas flow rate is supplied via the gas inlet connection 52 which is smaller than the gas flow rate needed by a patient in the current phase of the inspiration cycle. Thus, the patient can additionally inspire ambient air via the outlet connection 62, the channel 70, the inspiration arm 50 and the face piece 20.

An anti-suffocation valve 56 is provided in parallel to the dilution valve 72, which is redundant in EP 1 402 915 A1.

The gas reservoir bag 40 specifically has the purpose of temporarily storing gas supplied during the expiration via the gas inlet connection 52 for the subsequent inspiration. According to EP 1 402 915 A1 the advantage of the non-rebreathing mask (NRM) described in this patent document as compared to a partial rebreathing mask (PRM) is due to the fact that in a PRM the gas supplied via the gas inlet connection 52 is diluted by expired air already in the gas reservoir bag, while in an NRM exclusively supplied gas is temporarily stored in the gas reservoir bag.

Closely linked to this is the fact that the anatomical dead space is practically filled with inexpensive ambient air instead of expensive oxygenized air and that this ambient air is released again from the pulmonary vesicles into the ambiance during the expiration, largely without being mixed with oxygenized air. In fact, also the ambient air inspired at the end of the inspiration phase and intended for the dead space is accumulated with supplied gas to a small extent because the flow of the supplied gas is constant.

In EP 1 402 915 A1 it is assumed in an exemplary calculation that the respiratory volume of a patient amounts to 600 ml and that the anatomical dead space, which does not participate in the gas exchange with the blood, amounts to 200 ml. As a consequence, it is sufficient to supply per respiratory cycle slightly more than 400 ml of oxygen via the gas inlet connection 52 and to fill the anatomical dead space with ambient air, without thereby considerably reducing the effective oxygen concentration in the pulmonary vesicles.

In practice, the oxygen supply is adjusted to be far smaller, so that the patient inspires partly pure oxygen and partly ambient air. It is well known that the oxygen content of expired air amounts to approximately 16 percent. This is still sufficient to apply mouth-to-mouth respiration, for example, to the victim of an accident.

It follows from the aforesaid that, in normal operation, the gas reservoir bag is emptied completely during each inspiration and should never be filled to bursting because the gas supplied via the gas inlet connection 52 otherwise escapes into the ambiance through valves 54 and 64. The minimum volume of the gas reservoir bag 40 depends on the needs of the patient, whereby 500 ml is sufficient a volume for most of intensive care patients.

EP 1 402 915 A1 is based on the object to apply above all oxygen as effectively as possible so as to prolong, for example, the limited range of gas cylinders in rescue vehicles. Another problem is that the expired air of a patient may be dangerous to other patients or the hospital staff. Depending on the disease, the expired air may contain viruses or bacteria. The gas supplied via the gas inlet connection 52 may also contain medicine that can be dangerous to other patients. Therefore, a filter may be connected to the outlet connection 62.

Further known are respiratory apparatus or respirators for the mechanical artificial respiration in all forms of an oxygen deficiency state. They are employed, inter alia, for the long-term respiration, whereby a distinction is made between three basic types depending on the switchover mechanism from inspiration to expiration. With a pressure-controlled respirator the inspiration phase is completed when a predetermined inspiratory pressure in the apparatus has been reached. With the volume-controlled respirator the inspiration is completed when a previously adjusted gas volume has left the respirator. A spirometer measuring the tidal air of the patient is installed in the expiration leg of these apparatus. Additionally, these apparatus mostly include acoustic or optical warning signals. Finally, there are time-controlled respiratory apparatus releasing the gas mixture within a period entered beforehand. The expiration mostly takes place in a passive manner, but may also be supported by a generation of a negative airway pressure. The latest respiratory apparatus dispose of technical, mostly electronically controlled devices which allow for a respiration type that meets the needs of the patient. The inspiration time can, for example, be prolonged up to three times the expiration time, a pressurized respiration may be performed and the respirator may be triggered by the patient, whereby even weak breaths are pulse-generating for the mechanical support (Roche Medical Dictionary, 4^{th} Edition, edited by Hoffmann-La Roche AG and Urban & Fischer, Munich, Stuttgart, Jena, Lübeck, Ulm).

It is desirable to extend the range of application of a mask configuration known from EP 1 402 915 A1.

### SUMMARY OF THE INVENTION

According to an embodiment of the invention a gas reservoir bag comprises a flexible bag and an outer bag. The flexible bag separates two different gases and comprises a connection. The outer bag generates a pressure difference between the flexible bag and the ambiance of the outer bag, wherein the outer bag surrounds the flexible bag except for the connection thereof.

According to another embodiment of the invention a distributor housing for a respiratory mask comprises a connection for a face piece, an inspiration arm, an expiration arm, a gas inlet connection and a gas reservoir bag. The inspiration arm is connected to the connection for the face piece. The expiration arm is connected to the connection for the face piece. The gas inlet connection is connected to the inspiration arm. The gas reservoir bag is connected to the inspiration arm so as to allow gas to flow from the gas inlet connection and out of the gas reservoir bag via the inspiration arm to the connection for the face piece during an inspiration phase and to allow gas to flow from the gas inlet connection into the gas reservoir bag and from the connection for a face piece through the expiration arm during an expiration phase. The gas reservoir bag comprises a flexible bag and an outer bag. The flexible bag separates two different gases and comprises a connection. The outer bag generates a pressure difference between the flexible bag and the ambiance of the outer bag, wherein the outer bag surrounds the flexible bag except for the connection thereof. The connection of the flexible bag is connected to the inspiration arm.

According to a further embodiment of the invention a respiratory mask comprises a face piece and a distributor housing. The distributor housing comprises a connection for a face piece, an inspiration arm, an expiration arm, a gas inlet connection and a gas reservoir bag. The inspiration arm is connected to the connection for the face piece. The expiration arm is connected to the connection for the face piece. The gas inlet connection is connected to the inspiration arm. The gas reservoir bag is connected to the inspiration arm so as to allow gas to flow from the gas inlet connection and out of the gas reservoir bag via the inspiration arm to the connection for the face piece during an inspiration phase and to allow gas to flow from the gas inlet connection into the gas reservoir bag and from the connection for a face piece through the expiration arm during an expiration phase. The gas reservoir bag comprises a flexible bag and an outer bag. The flexible bag separates two different gases and comprises a connection. The outer bag generates a pressure difference between the flexible bag and the ambiance of the outer bag, wherein the outer bag surrounds the flexible bag except for the connection thereof. The connection of the flexible bag is connected to the inspiration arm. The connection for a face piece of the distributor housing is connected to the face piece.

According to yet a further embodiment of the invention a respiration method for respiring a patient with a gas mixture is provided. The composition of the gas mixture deviates from the composition of the ambient air. The method includes supplying the gas mixture during both, the inspiration and the expiration. The method further comprises introducing the gas mixture into a flexible bag during the expiration. The method further comprises inspiring the supplied gas mixture and the gas mixture provided in the bag during the inspiration. The method further comprises supplying ambient air at a positive pressure with respect to the ambient air pressure during the inspiration. The method further comprises compressing the gas mixture in the flexible bag to the same pressure at which the ambient air is supplied.

It is an advantage of a double-walled gas reservoir bag that the inner bag can temporarily store during the expiration a gas additionally used for the respiration, while the outer bag accommodates the positive airway pressure generated by a respiratory apparatus during the inspiration.

It is an advantage of the introduction of the air conveyed by a respiratory apparatus into the space between the inner and the outer bag that the positive airway pressure generated by the respiratory apparatus can thus be compensated in a simple manner. Furthermore, it is surprisingly advantageous that by this procedure not even the inspiration volume measured by the respiratory apparatus is misrepresented. The air volume flowing into the space between the two bags and thus not being available to the inspiration is replaced by gas from the inner bag. The measuring result is misrepresented merely by the largely constant gas stream through the gas inlet connection 52.

If the outer bag comprises two connections, namely one for connecting a respiratory tube and one for being connected to a distributor housing, the double-walled gas reservoir is optimally fitted into a modular system. If the outer bag is rigid, the outer bag can also compensate a negative airway pressure which occurs if a respirator also supports the patient during the expiration.

The gas reservoir bag may advantageously also be integrated in a distributor housing, or both articles may be packed together as throw-away articles.

The same applies to the additional integration of a face piece or to the addition of the same to a package unit.

### BRIEF DESCRIPTION OF THE DRAWINGS

Preferred embodiments of the invention will hereinafter be explained in more detail with reference to the enclosed drawings, wherein like numerals represent like parts. In the drawings:

FIG. 1 shows a mask configuration according to the invention; and

FIG. 2 shows a mask configuration according to the prior art.

### DETAILED DESCRIPTION OF THE INVENTION

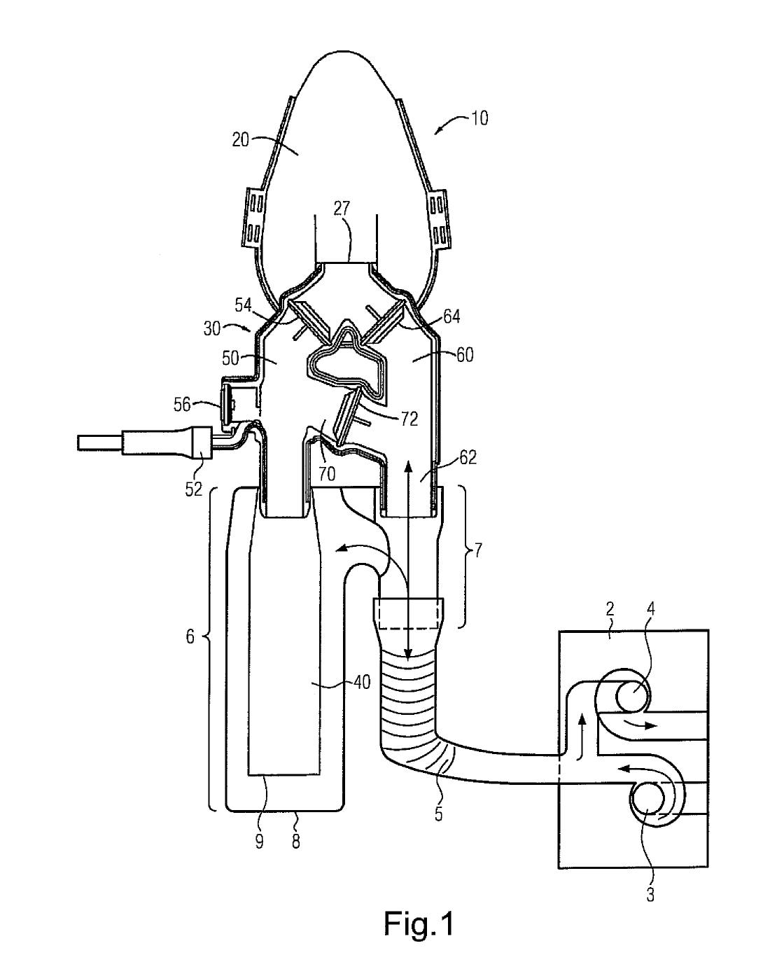

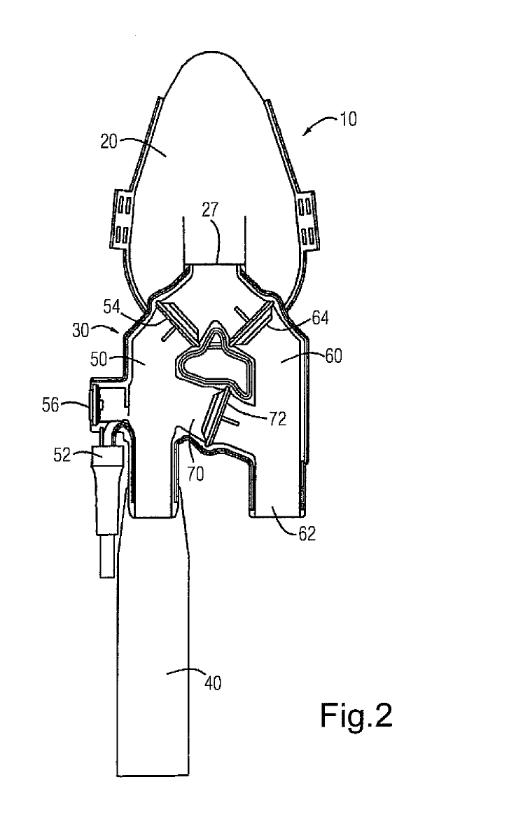

FIG. 1 shows a mask configuration according to the invention. It differs from the mask configuration shown in FIG. 2 substantially by the double-walled gas reservoir bag 6 which allows the connection of a respirator 2 by means of a respiratory tube 5.

Similar to the gas reservoir bag 40, the inner flexible bag 9 merely serves as a separation wall between the gas, mostly oxygen, in its interior and the ambient air between the inner and outer bag 8. The inner bag 9 is flexible so as to possibly generate no pressure difference between its interior and exterior.

The outer bag 8 serves the compensation of the positive airway pressure generated by the respirator 2 during the inspiration. The outer bag 8 is filled to bursting at least during the inspiration and should change its volume at common inspiratory pressures as little as possible.

To facilitate the handling, a respiratory tube-like Y-piece 7 is provided. At its upper end the Y-piece 7 is formed to fit on the outlet connection 62. The lower part of the Y-piece 7 corresponds to the outlet connection 62 so as to allow a respiratory tube 5 to be connected thereto. Thus, the distributor housing 30 may be equipped with a simple gas reservoir bag 40 or with a double-walled gas reservoir bag 6 according to need.

The Y-piece 7 serves to partially introduce ambient air delivered by the respirator 2 under a positive airway pressure into the space between the inner bag 9 and the outer bag 8 so as to compress the gas in the inner bag 9 to this positive airway pressure. The remaining ambient air supplied by the respirator 2 is conducted further to the face piece 20 via channel 70, dilution valve 72, inspiration arm 50 and inspiration valve 54.

In the respirator 2 two turbines 3 and 4 are drawn in to indicate that this respirator is able to generate both a positive and a negative airway pressure for supporting the inspiration and the expiration by turbine 3 and 4, respectively. If a negative airway pressure is generated by the respirator 2 the outer bag 8 must be rigid, so that the expression “housing” would be more appropriate as compared to “bag”.

Finally, it is noted that the anti-suffocation valve 56 and the dilution valve 72 are not redundant in the construction according to FIG. 1 because the dilution valve 72 leads to the respirator 2 and not directly to the ambient air. Should the respirator 2 generate a negative airway pressure by means of the turbine 4, this pressure is transferred via the inner bag 9 also into the inspiration arm 50. The release pressure of the anti-suffocation valve 56 must be greater with respect to its amount than this negative airway pressure because the gas supplied via the gas inlet connection 52 is otherwise diluted with ambient air.

Unless indicated otherwise, “connected” is to imply that there can be a gas flow between the two connected parts.

In the present application, gas mixture also includes a pure gas, e.g. for medical purposes, in particular oxygen.

Above, the invention was explained in more detail by means of preferred embodiments. A person skilled in the art will appreciate, however, that various alterations and modifications may be made without departing from the spirit of the invention. Therefore, the scope of protection will be defined by the following claims and their equivalents.

### List of Reference Numerals

1 mask configuration
2 respirator
3 turbine
4 turbine
5 respiratory tube
6 gas reservoir bag
7 Y-piece
8 outer bag
9 inner bag
10 mask configuration
20 face piece
27 clearance
30 distributor housing
40 gas reservoir bag
50 inspiration arm
52 gas inlet connection
56 anti-suffocation valve
60 expiration arm
62 outlet connection
64 expiration valve
70 channel
72 dilution valve

What is claimed is:

1. A gas reservoir bag, comprising:
a flexible bag for separating two different gases, the flexible bag comprising a connection;
an outer bag for generating a pressure difference between the flexible bag and the ambiance of the outer bag, the outer bag surrounding the flexible bag except for the connection of the flexible bag.

2. The gas reservoir bag according to claim 1, the outer bag further comprising a connection by means of which the outer bag being connectable to a respirator.

3. The gas reservoir bag according to claim 1, the outer bag further comprising a first and a second connection, the first connection being adapted for connecting a respiratory tube and the second connection being adapted for being connected to a distributor housing.

4. The gas reservoir bag according to claim 3, the outer bag being reinforced between the two connections and being formed in a respiratory tube type manner between the two connections, wherein the second connection fits onto an outlet connection of the distributor housing and the first connectionbeing formed like the outlet connection itself.

5. The gas reservoir bag according to claim 1, the outer bag being rigid.

6. A distributor housing for a respiratory mask, comprising:
a connection for a face piece;
an inspiration arm connected to the connection for the face piece;
an expiration arm connected to the connection for the face piece;
a gas inlet connection connected to the inspiration arm; and
a gas reservoir bag connected to the inspiration arm so as to allow gas to flow from the gas inlet connection and out of the gas reservoir bag via the inspiration arm to the connection for the face piece during an inspiration phase and to allow gas to flow from the gas inlet connection into the gas reservoir bag and from the connection for a face piece through the expiration arm during an expiration phase; the gas reservoir bag comprising:
a flexible bag for separating two different gases, the flexible bag comprising a connection which is connected to the inspiration arm; and
an outer bag for generating a pressure difference between the flexible bag and the ambiance of the outer bag, the outer bag surrounding the flexible bag except for the connection of the flexible bag.

7. The distributor housing according to claim 6, wherein also the outer bag comprises a connection by means of which the outer bag is connected to an outlet connection of the expiration arm.

8. A respiratory mask, comprising:
a face piece; and
a distributor housing, comprising:
a connection for a face piece being connected to the face piece;
an inspiration arm connected to the connection for the face piece;
an expiration arm connected to the connection for the face piece;
a gas inlet connection connected to the inspiration arm; and
a gas reservoir bag connected to the inspiration arm so as to allow gas to flow from the gas inlet connection and out of the gas reservoir bag via the inspiration arm to the connection for the face piece during an inspiration phase and to allow gas to flow from the gas inlet connection into the gas reservoir bag and from the connection for a face piece through the expiration arm during an expiration phase; the gas reservoir bag comprising:
a flexible bag for separating two different gases, the flexible bag comprising a connection which is connected to the inspiration arm; and
an outer bag for generating a pressure difference between the flexible bag and the ambiance of the outer bag, the outer bag surrounding the flexible bag except for the connection of the flexible bag.

9. A respiration method for respiring a patient with a gas mixture the composition of which deviates from the composition of the ambient air; including:
supplying a gas mixture, the composition of which deviates from the composition of the ambient air, during both the inspiration and the expiration;
introducing the gas mixture into a flexible bag during the expiration;
inspiring the supplied gas mixture and the gas mixture provided in the bag during the inspiration;
supplying ambient air at a positive pressure with respect to the ambient air pressure during the inspiration; and
compressing the gas mixture in the flexible bag to the same pressure at which the ambient air is supplied.

10. The respiration method according to claim 9, further comprising introducing the supplied ambient air at least partially into a space between an outer bag and the flexible bag, wherein the outer bag surrounds the flexible bag.
